(19) United States
(12) Patent Application Publication
(10) Pub. No.: US 2008/0303870 A1
(43) Pub. Date: Dec. 11, 2008

(54) Ink Jet Device for the Positioning of a Substance Onto a Substrate, Method for the Positioning of a Substance Onto a Substrate and Use of an Ink Jet Device

(75) Inventors: Roy Gerardus Franciscus Antonius Verbeek, Eindhoven (NL); Richard Joseph Marinus Schroeders, Eindhoven (NL); Aleksey Kolesnychenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,513

(22) PCT Filed: Dec. 19, 2006
(86) PCT No.: PCT/IB06/54942

§ 371 Date: Jun. 20, 2008

(30) Foreign Application Priority Data
Dec. 22, 2005 (EP) 05112687.8

(51) Int. Cl. B41J 2/05

(52) U.S. Cl. 347/56

(57) ABSTRACT

The invention provides an ink jet device for the positioning of a substance onto a substrate, the device comprising at least a print head comprising a nozzle provided to eject a droplet comprising the substance, the ink jet device further comprising at least one heating element arranged such that the substrate can be heated prior to, during and/or after the landing of a droplet on the substrate.

The present invention relates to an ink jet device for the positioning of a substance onto a substrate. The present invention further relates to a method for the positioning of a substance onto a substrate using an ink jet device. The present invention further relates to the use of an ink jet device.

The present invention discloses an ink jet device the positioning of a substance onto a substrate, a method and the use of an ink jet device. Especially for medical diagnostics, substrates are needed where specific substances are positioned in a very precise and accurate manner. These substances are usually to be positioned on a substrate in order perform a multitude of biochemical tests or reactions on the substrate. The ink jet device, the method for the positioning of a substance onto a substrate and the use of an ink jet device according to the present invention are preferably applied to the printing process of substances onto a substrate, where the substance is positioned in a specific manner onto and into a spot region of the material of the substrate. It is important to be able to control the concentration of the substance and the distribution of the substance in the spot region of the substrate.

Ink jet devices are generally known. For example, U.S. patent application US 2004/0196319 A1 discloses an image recording apparatus including a recording head having a plurality of nozzles, a carriage, a transfer mechanism, a driving mechanism, a detection mechanism which optically detects an injection date and a controller. The plurality of nozzles are divided into a plurality of nozzle groups. The controller makes an injection timing of each of the nozzle groups different from that of any other nozzle group. The recording head or the plurality of recording heads according to the above cited U.S. patent application can be positioned outside a printing area such that a control operation can be performed. The control operation can provide an answer to the question, whether one or a plurality of printing heads or printing nozzles do not work correctly, for example because ink is plugging the nozzle or the like. When the printing head is positioned outside the printing area in the control or detection area, the printing heads or printing nozzles do not face the recording medium onto which the print heads apply ink droplets in the printing area. In the detection area, the trajectory of droplets intersect with a light beam detected by a photo detector leading to a control of the proper working of the printing head. One drawback of the known device is that the distribution of the substance in the spot region of the substrate is not influenceable. This limits the possibility to use the printed substance for further diagnostic purposes because especially the lowest detectable concentrations of e.g. fluorescence particles are to important.

It is therefore an objective of the present invention to provide an ink jet device for the controlled positioning of droplets of a substance onto a substrate that has the possibility for a controllable and predefined distribution of the printed substance in a spot area or spot region of the substrate.

The above objective is accomplished by an ink jet device and a method for the positioning of a substance onto a substrate according to the present invention and by the use of an ink jet device according to the present invention. The ink jet device for the positioning of a substance onto a substrate comprises at least a print head comprising a nozzle provided to eject a droplet comprising the substance. The ink jet device further comprises at least one heating element arranged such that the substrate can be heated prior to, during and/or after the landing of a droplet on the substrate.

By means of heating the substrate, it is very advantageously possible to provide a predefined distribution of the printed substance in the spot area which is very useful especially in order to enhance the possibility of detecting the results of biochemical reactions taking place at the spot area between, inter alia, the printed substance. For example, a distribution of the printed substance with a higher concentration of the molecules of the printed substance in a smaller area makes it possible that labelled molecules (especially by means of fluorescent labels) are fixed or bound to that area in a higher concentration and thereby leading to better optical detectability.

Furthermore, to provide a predefined distribution of the printed substance in the spot area is also very useful in order to enhance the probability of (bio chemical) reactions (especially hybridisation reactions) taking place at the spot area.

Very preferably, the print head is provided on a first side of the substrate and the at least one heating element is provided on a second side of the substrate opposite of the first side. This has the advantage, that no space on the first side of the substrate has to be used for the heating element. This is especially important because space around the print head is at a premium because the closer the print head is positioned to the substrate, the more accurate the landing of the droplet is.

Furthermore, the droplet is not directly heated by the heating element prior to the landing of the droplet on the substrate.

Furthermore, the heating element is a light source, especially a LED (light emitting diode) and/or an infrared light source and/or a light source radiating with an absorbed wavelength which is different than infrared. Thereby a very cost-effective way of providing a heating element is chosen according to the invention.

In a preferred embodiment of the present invention, the ink jet device comprises a plurality of heating elements. This has the advantage, that it is possible to heat only relevant regions of the substrate whereas other regions of the substrate where no printing process takes place need not be heated.

It is further preferred that the substrate comprises a plurality of substrate areas, each substrate area preferably being a separated membrane held by a membrane holder. Thereby, a plurality of separated membranes are possible to produce by the use of the inventive ink jet device.

Very preferably, at least one heating element is assigned to each substrate area. This has the advantage, that a still better and more adapted heating of the substrate is possible.

It is further preferred that the ink jet device comprises a print table or a fixture plate wherein the print table or the fixture plate comprises a recess or a hole for each membrane holder and/or that the heating element assigned to each substrate area is provided in the recess or hole. A precise heating of the different membrane areas is thereby possible.

It is much preferred according to the present invention to use an ink jet device where the ink jet device further comprises a (preferably stable and heavy) print table and a printing bridge, a fixture plate mounted rigidly to a linear stage allowing for linear motion along a first direction (X-direction) relative to the print table and the print head being attached to a print head holder, which is mounted on a linear stage allowing for linear motion relative to the printing bridge along a second direction (Y-direction). Thereby it is possible to print or release droplets of a substance to a large area of application such that the production of printed products can be made quite cost effective because large substrates or individual membranes can be printed as one batch.

According to the present invention, it is preferred that the substrate is a flat substrate, a structured substrate or a porous substrate. More preferably, the substrate is a nylon membrane, nitrocellulose membrane or PVDF. Because the substrate is preferably porous, the spots or the droplets do not only lie on the surface, but also penetrate into the membrane.

Further preferably, the substrate comprises a plurality of substrate locations, the substrate locations being separated from each other at least the average diameter of a droplet positioned at one of the substrate locations. Thereby, it is possible to precisely and independently locate different droplets of a substance at precise location on the substrate. It is also possible and advantageous to place a plurality of droplets on the same substrate location.

According to the present invention it is very much preferred, that the substance is transparent or strongly translucent. Very preferably the substance is an aqueous solution where different molecules or different compounds, especially bio-molecules are present. Of course, every kind of solution where the bio molecules are stable and which is printable can be used according to the present invention. It is also possible to use a solution which absorbs the radiation of the heating element, e.g. by means of providing colorants in the solution.

The present invention also includes a method for the positioning of a substance onto a substrate using an ink jet device comprising at least a print head comprising a nozzle provided to eject a droplet comprising the substance, the ink jet device further comprising at least one heating element arranged such that the substrate can be heated prior to, during and/or after the landing of a droplet on the substrate.

Thereby, a very advantageous and controllably predefined distribution of the substance in the spot region of the substrate is possible to achieve.

According to the present invention, it is preferred that the substrate is heated such that the substance at one spot is more concentrated in an upper half of the substrate facing a first side of the substrate than in a lower half of the substrate facing a second side, wherein in the print head is provided on the first side of the substrate and wherein the at least one heating element is provided on the second side of the substrate opposite of the first side. It is thereby possible to define an advantageous distribution of the substance such that a detection of fluorescent particles is much more simplified.

Further preferably, the substrate is heated such that the substance at one spot is substantially located in the upper half of the substrate. Thereby, even a greater concentration with a better detection possibilities of labels (e.g. fluorescent particles) is possible.

In a still further preferred embodiment, a plurality of different substances are applied to the substrate such that a first substance is positioned at a first substrate location and the second substrate is positioned at a second substrate location. This has the advantage, that by performing one and the same printing process and by only exchanging a print head or a substance reservoir to print, a multitude of different substances on the substrate is possible to realise which can be used in a biochemical assay cartridge.

The present invention also includes the use of an inventive ink jet device according to the present invention, wherein the substance comprises a biochemical reactant and/or a nucleic acid and/or a polypeptide and/or a protein. By using the inventive ink jet device for such a purpose, it is possible to very accurately and precisely locate a certain number of substances on a substrate.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

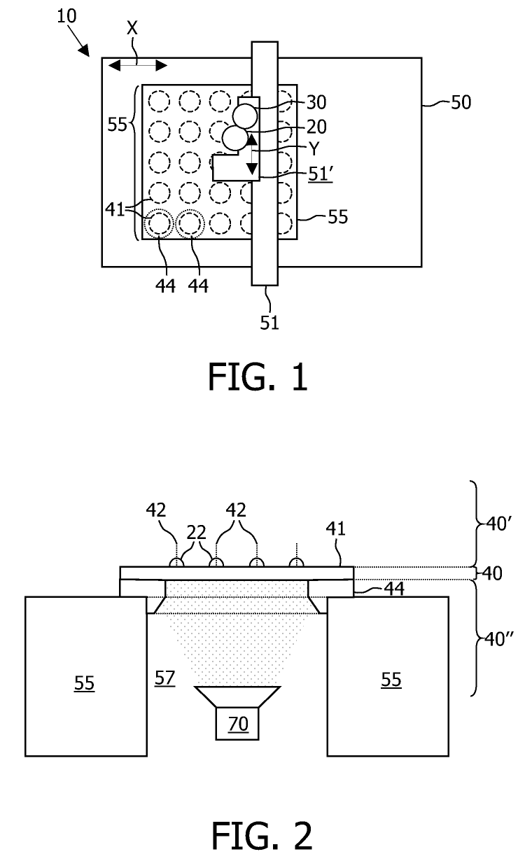

FIG. 1 illustrates schematically a top view of an embodiment of the ink jet device of the present invention,

FIG. 2 illustrates schematically a cross section through a substrate area, a membrane holder and a fixture plate,

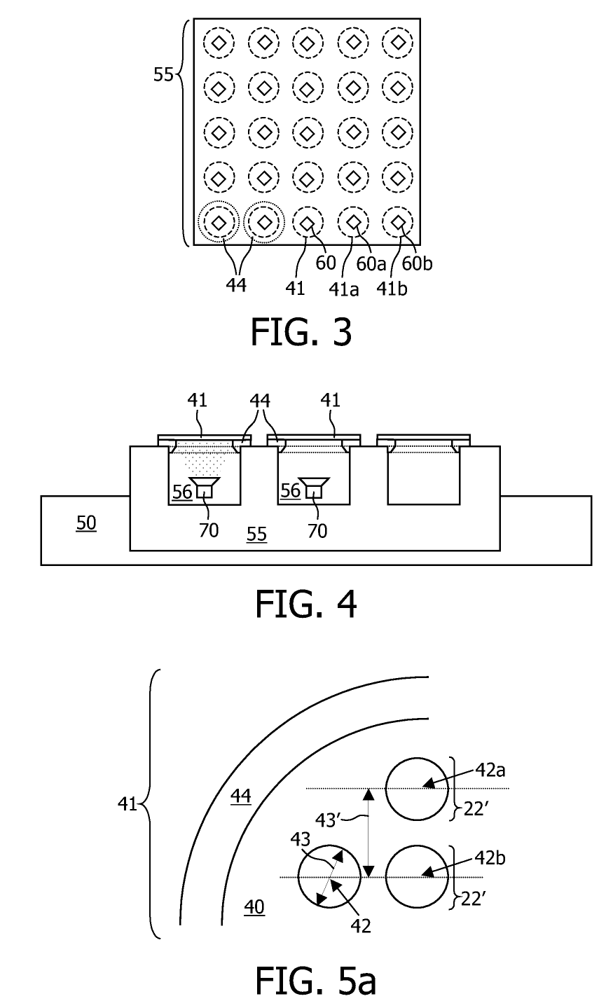

FIG. 3 illustrates schematically a fixture plate of an inventive ink jet device with a plurality of membrane areas and heating elements,

FIG. 4 illustrates schematically an alternative embodiment of a fixture plate of an inventive ink jet device.

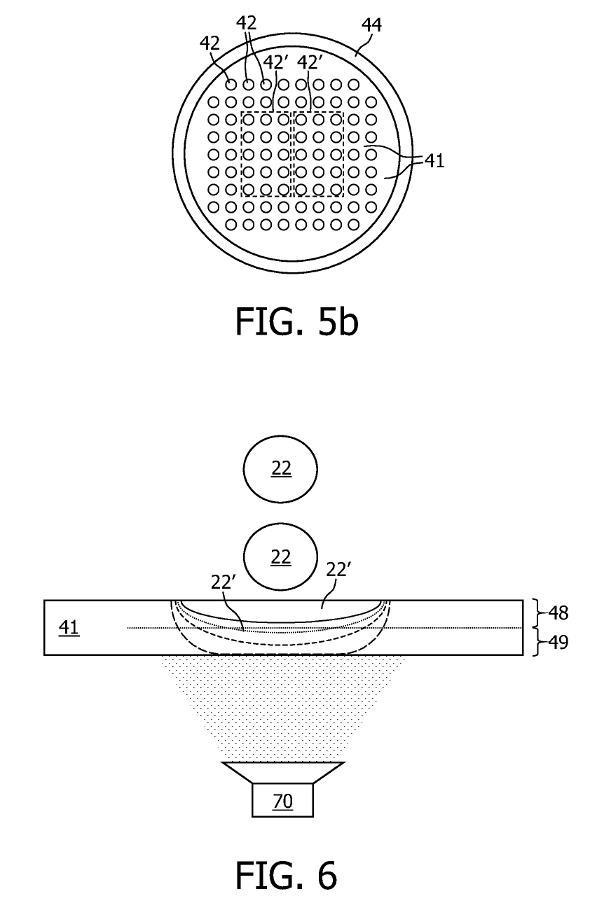

FIGS. 5a and 5b illustrate schematically a part of a substrate area together with a membrane holder and a complete membrane,

FIG. 6 illustrates schematically a more detailed view of substrate section with a spot of a substance.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, a schematic top view of the ink jet device 10 according to the present invention is shown. On a print table 50 (preferably made of heavy granite) a fixture plate 55 is fixedly attached to a linear stage allowing for a linear motion with respect to the granite table. In this fixture plate 55, a number of membrane holders 44 with membranes 41 are positioned. The membranes 41 together form the substrate 40. Therefore, the membranes 41 could also be called “substrate 41”. For the sake of clarity, in the following, the term “substrate 40” refers to the totality of the printable area of the “membranes 41”. The membrane holder 44 is basically only a ring 44. A round membrane 41 is welded onto this ring. So, after printing, the ring 44 with membrane 41 together is the final product. A printing bridge 51 is provided moveably relative to the fixture plate 55 and rigidly mounted relative to the print table 50. The printing bridge 51 carries the moveable print head holder 51′. The stage with the fixture plate 55 is moveable along a first direction, the X-direction. A print head 20 is mounted to the moveable print head holder 51′ such that it is moveable along a second direction, Y-direction, relative to the printing bridge 51. Of course, it is also possible that the fixture plate 55 is movable both in the first direction (X-direction) and in the second direction (Y-direction) and that the print head 20 is fixed. In the following, only the embodiment with the fixture plate movable in the first direction (X-direction) and the print head 20 movable in the second direction (Y-direction) is described without restricting the scope of the present invention. According to the present invention, it is preferred, that the first direction (X-direction) and the second direction (Y-direction) are orthogonal. Thereby, the print head 20 can be moved over a certain area of a fixture plate 55 and can release droplets of a substance which is stored in a reservoir (not shown) near the print head 20. The membranes 41 are mounted in the fixture plate 55, also called registration plate 55, at uniform distance in X-direction and uniform distance in Y-direction. The distance in X-direction may differ from the distance in Y-direction. In the embodiment of FIG. 1, a control camera 30 is provided such that a droplet (shown in FIG. 2) of a substance being ejected from a nozzle of the print head 20 can be detected by the control camera 30. In a preferred embodiment of the present invention shown in FIG. 1, the control camera 30 is fixedly positioned near the print head 20 on the movable print head holder 51′.

The print table 50 is preferably provided in the form of a granite table. Alternatively, another very heavy material can also be used. According to the present invention, the print table 50 should be arranged in an environment which has very little vibrational disturbances. A precision linear stage is mounted relative to the granite table (print table 50) and a fixture plate 55 mounted on the stage moves by definition in the first direction (X-direction).

In FIG. 2, a schematic representation of a cross sectional view of an individual membrane holder 44 and a part of the fixture plate 55 is shown. The membrane holder 44 carries one membrane 41 as a part of the substrate 40. One membrane 41 is also called a substrate area 41. Each individual membrane holder 44 is located on the fixture plate 55. On the substrate 40, i.e. on each membrane 41, a plurality of substrate locations 42 are provided such that an individual droplet or dot of a droplet (schematically shown by reference sign 22 in FIG. 2) is able to be located at a distance from one another. Thereby, it is possible to dispense or to position a different kind of substance on each of the substrate locations 42. The membrane holder 44 is positioned in a hole 57 of the fixture plate 55 or registration plate 55.

The substrate 40 may be made of a bio active membrane used for the detection of infectious diseases. Medical diagnostics demands for a very high reliability of the printing process. The read out of the fluorescent pattern relates diseases directly to the positions of the specific capture probes. Therefore, it is necessary to have a very reliable process for the correct positioning of the capture probes on the substrate 40. Ink jet printing is a precision dosing technique without any feedback about the actual presence and placements of the droplets on the substrate 40. The problem is that there is no information about the distribution of the substance in the substrate 40, i.e. for example about the penetration depth of the substance. The present invention describes the possibility to control the distribution of the substance in the substrate 40. Normally, a droplet 22 contains the substance 23 to be positioned on the substrate 40. The droplet 22 normally also contains a solvent, e.g. water or an alcohol. The solvent normally evaporates after the droplet 22 has been placed on the substrate 40. By means of a heating element 70, especially a light source (e.g. a LED, light emitting diode) emitting exclusively or inter alia infra red light and/or thermal radiation, it is possible to controllably heat the substrate 40 prior to, during and/or after the landing of the droplet 22 on the substrate 40.

The print head 20 of the ink jet device 10 is preferably located on a first side 40′ (“above”) of the substrate 40 and the heating element 70 is preferably located on a second side 40″ (“below”) of the substrate 40 where the second side 40″ is located opposite of the first side 40′. The heating element 70 is only schematically shown in FIG. 2, i.e. for example without connecting lines or the like. It is evident for someone skilled that such connecting lines have to be present in order to be able to actuating the heating element 70 by a processing and/or control device (not shown). Preferably, the heating element 70 is provided as a light source.

In FIG. 3, a schematical top view of a fixture plate 55 with a plurality of membrane areas 41, 41a, 41b and heating elements 70, 70a, 70b. To each membrane area 41, 41a, 41b, one heating element 70, 70a, 70b is assigned. This means that e.g. the heating element 70a assigned to the membrane area 41a is able to heat the membrane area 41a if the heating element 70a is actuated. The same is the case for the heating element 70b assigned to the membrane area 41b and for the heating element 70 assigned to the membrane area 41. By means of this plurality of heating element 70, located at different positions on the substrate 40, it is possible to heat precisely and independently a membrane area 41. By this, it is possible to heat the membrane area 41 prior to the landing of a droplet 22 and/or during the landing of the droplet 22 and/or after the landing of the droplet 22.

In FIG. 4, a schematic illustration of an alternative embodiment of a fixture plate 55 of an inventive ink jet device 10 is shown. In this alternative embodiment of the fixture plate 55, the membrane holders 44 are located in recesses 56 of the fixture plate 55. In these recesses 56, the heating elements 70 are schematically shown. On the membrane holders 44, the membrane areas 41 are located.

In FIG. 5a, a part of a membrane 41 or a substrate area 41 is shown from the top. On the substrate area 41 are defined a plurality of substrate locations 42, 42a, 42b. The substrate locations 42, 42a, 42b are the locations, where the droplets 22 are to be positioned by the ink jet device 10 according to the present invention. Is it also possible to place a plurality of droplets on one single substrate location 42. The droplets 22 which have been ejected by the print head 20 and landed on the substrate 40 will cover a certain droplet area 22′ or spot 22′ around the substrate locations 42, 42a, 42b with an average diameter 43 which is lower than the respective distance 43′ (or pitch) of the substrate locations 42, 42a, 42b from one another. Very preferably, a spot 22′ is made of one single or of a plurality of droplets 22.

In FIG. 5b a top view of a substrate area 41 is shown where a plurality of substrate locations 42 are represented by small circles. According to the present invention, many different substances can be positioned on these different substrate locations 42 in order to use the membrane of the substrate area 41 for diagnostic purposes. According to the present invention, it is possible to define several groups 42′ of substrate locations 42 in order to perform a complete set of tests within one group 42′ of substrate locations 42 and their respective substances.

In FIG. 6, a more detailed view of a section of the substrate 40/the membrane 41 with a spot 22′ of the substance 23 is shown. The heating element 70 is provided below the substrate 40/the membrane 41. Further two droplets 22 are shown during their movement towards the substrate 40. The droplets 22 comprise generally the substance 23 as well as a solvent (not shown). The solvent evaporates after the landing of the droplet 22 on the membrane 41. The evaporation of the solvent depends strongly on the temperature of the membrane 41 during the landing of the droplet 22. The evaporation time after which the solvent of one single droplet 22 is completely evaporated influences the penetration depth of the substance 23 into the material of the membrane. By heating the membrane 41/the substrate 40 prior to and/or during and/or after the landing of the droplet 22 on the membrane 41, it is possible to control the evaporation time as well as the penetration depth of the substance 23 into the material of the membrane 41.

In FIG. 6, four different cases of different penetration depth are represented by different line configurations. A first penetration depth of a droplet spot 22′ of the substance 23 is represented by a drawn-through line. In the example of the first penetration depth, the substance 23 is only located in a upper half 48 of the substrate 40 or the membrane 41, whereas a lower half 49 of the substrate 40 is completely free or at least substantially free of the substance 23. A second penetration depth of a droplet spot 22′ of the substance 23 is represented by a dashed line with small dashes, a third penetration depth of a droplet spot 22′ of the substance 23 is represented by a dashed line with medium dashes and a fourth penetration depth of a droplet spot 22′ of the substance 23 is represented by a dashed line with long dashes. The third penetration depth and more strongly the second penetration depth is provided such that the substance is more concentrated in the upper half 48 of the substrate 40/the membrane 41 than in the lower half 49 of the substrate 40 whereas the upper half 48 is facing the first side 40′ (cf. FIG. 2) and whereas the lower half 49 is facing the second side 40″ (cf. FIG. 2).

According to the invention, the print protocol is processed preferably in the following manner: Preferably, the membranes 41 are firstly aligned relative to the print table 50 or the fixture plate 55. By doing this, it can be made sure that the position information of the droplet 22 is known in three dimensions. The ejection of a droplet 22 out of a print head 20, 20a, 20b is preferably detected by cameras. All the signals and data from the sensors or cameras are recorded by software and stored in a memory.

On a substrate area 41, for example 130 spots or substrate locations 42 can be provided where droplets 22 can be printed, each droplet needing a volume of, e.g., around 1 nl. The diameter 43 of the spots or the droplets 22 is for example 200 μm and they are placed in a pattern with a pitch of, e.g., 400 μm. Of course, it is also possible to provide smaller spots necessitating only a smaller pitch of, for example, 300 μm or only 200 μm, 100 μm or 50 μm. The 130 spots are printed for example with one single print head 20 and/or in parallel with multiple print heads and/or in parallel with multiple nozzles which is/are provided with different substances 23. For example, on the fixture plate 55, 140 pieces of membrane holders 44 are arranged which are processed in one batch of printing by the ink jet device 10. The pitch 43′ of the droplet spots is provided in the range of 10 to 500 μm according to the present invention. The diameter 43 of the spots of the droplets 22 is in the range of about 20% to 70% of the actual pitch 43′. The volume of the droplets 22 has to be adapted to the preferred size of the spot and to the material of the substrate 40 used (e.g. dependent of where the substrate strongly or weakly absorbs the substance applied). Typically, the volume of the droplets 22 is about 0.001 nl to 10 nl. Also, the concentration of the substances 23 to print can be varied.

1. Ink jet device (10) for the positioning of a substance (23) onto a substrate (40), the device (10) comprising at least a print head (20) comprising a nozzle (21) provided to eject a droplet (22) comprising the substance (23), the ink jet device (10) further comprising at least one heating element (70) arranged such that the substrate (40) can be heated prior to, during and/or after the landing of a droplet (22) on the substrate (40).

2. Ink jet device (10) according to claim 1, wherein the print head (20) is provided on a first side (40′) of the substrate (40) and wherein the at least one heating element (70) is provided on a second side (40″) of the substrate (40) opposite of the first side (40′).

3. Ink jet device (10) according to claim 1, wherein the heating element (70) is a light source, especially a LED and/or an infrared light source and/or a light source radiating with an absorbed wavelength which is different than infrared.

4. Ink jet device (10) according to claim 1, wherein the ink jet device (10) comprises a plurality of heating elements (70, 70a, 70b).

5. Ink jet device (10) according to claim 1, wherein the substrate (40) comprises a plurality of substrate areas (41), each substrate area (41) preferably being a separated membrane (41) held by a membrane holder (44).

6. Ink jet device (10) according to claim 5, wherein at least one heating element (70, 70a, 70b) is assigned to each substrate area (41, 41a, 41b).

7. Ink jet device (10) according to claim 6, wherein the ink jet device (10) comprises a stationary print table (50) and a movable a fixture plate (55) wherein the fixture plate (55) comprises a recess (56) or a hole (57) for each membrane holder (44).

8. Ink jet device (10) according to claim 7, wherein the heating element (70, 70a, 70b) assigned to each substrate area (41, 41a, 41b) is provided in the recess (56) or hole (57).

9. Ink jet device (10) according to claim 1, wherein the ink jet device (10) further comprises a print table (50) and a printing bridge (51) rigidly attached to the table, a fixture plate (55) being mounted movably relative to the print table (50) along a first direction (X-direction) and the print head (20) being mounted on a movable print head holder (51′) being mounted to the printing bridge (51) such that the print head (20) is movable relative to the printing bridge (51) along a second direction (Y-direction).

10. Ink jet device (10) according to claim 9, wherein the first direction (X-direction) and the second direction (Y-direction) are orthogonal.

11. Ink jet device (10) according to claim 1, wherein the substrate (40) is a flat substrate, a structured substrate or a porous membrane (41), preferably a nylon membrane, a nitrocellulose membrane or a PVDF membrane.

12. Ink jet device (10) according to claim 1, wherein the substrate (40) comprises a plurality of substrate locations (42, 42a, 42b), the substrate locations (42, 42a, 42b) being separated from each other by at least the average diameter (43) of a spot (22′) positioned at one of the substrate locations (42, 42a, 42b).

13. Ink jet device (10) according to claim 1, wherein a plurality of droplets (22) are superposed on one substrate location (42, 42a, 42b) to form a spot (22′).

14. Ink jet device (10) according to claim 1, wherein the substance (23) is transparent or strongly translucent.

15. Method for the positioning of a substance (23) onto a substrate (40) using an ink jet device (10) comprising at least a print head (20) comprising a nozzle (21) provided to eject a droplet (22) comprising the substance (23), the ink jet device (10) further comprising at least one heating element (70) arranged such that the substrate (40) can be heated prior to, during and/or after the landing of a droplet (22) on the substrate (40).

16. Method according to claim 15, wherein the substrate (40) is heated such that the substance (23) at one spot (22′) is more concentrated in an upper half (48) of the substrate (40) facing a first side (40′) of the substrate (40) than in a lower half (49) of the substrate (40) facing a second side (40″), wherein in the print head (20) is provided on the first side (40′) of the substrate (40) and wherein the at least one heating element (70) is provided on the second side (40″) of the substrate (40) opposite of the first side (40′).

17. Method according to claim 16, wherein the substrate (40) is heated such that the substance (23) at one spot (22′) is substantially located in the upper half (48) of the substrate (40).

18. Method according to claim 15, wherein a plurality of different substances (23) are applied to the substrate (40) such that a first substance (23a) is positioned at a first substrate location (42a) and a second substance (23b) is positioned at a second substrate location (42b).

19. Use of an ink jet device (10) according to claim 1, wherein the substance (23) comprises a biochemical reactant and/or a nucleic acid and/or a polypeptide and/or a protein.
